(19) United States
(12) Patent Application Publication
(10) Pub. No.: US 2007/0069951 A1
(43) Pub. Date: Mar. 29, 2007

(54) Remote object locator and method

(76) Inventor: Margaret A. Sweet, South Dartmouth, MA (US)

Correspondence Address: Joseph P. Quinn, Esq.;Cesari and McKenna LLP, 88 Black Falcon Avenue, Boston, MA, 02210, US

(21) Appl. No.: 11/235,845

(22) Filed: Sep. 27, 2005

(51) Int. Cl. G01S 3/02

(52) U.S. Cl. 342/457

(57) ABSTRACT

A device for locating an object such as a vehicle in a parking lot by remotely actuating playback circuitry in communication with a loudspeaker disposed with the object. The device is capable of recording and playing back audio signals from any number of sources. A portable transmitter carried by a user can activate the playback circuitry from a distance of at least several hundred feet and the loudspeaker can be heard from a similar distance.

### FIELD OF THE INVENTION

The present invention relates to the field of consumer electronics and more particularly to automotive accessories.

### BACKGROUND OF THE INVENTION

Many devices having inexpensive remote transmitters and receivers are heretofore known for consumers to remotely control various systems. Devices for remotely locking automobile doors, remotely starting an automobile's engine and remotely actuating or disabling automotive and home alarm system are commonly used. Consumers are accustomed to carrying small transmitters for actuating these devices, for example, on key rings or built into their automobile keys.

Certain remotely actuated devices used in automobile locking and alarm systems are designed to emit a chirp or beeping of vehicle's horn to acknowledge that a control signal has been received, and thereby assure the user that the system has been actuated, i.e., that the vehicles doors are locked. Panic buttons are often incorporated in such devices to actuate a horn or loudspeaker so that a loud noise is emitted from the vehicle.

The noises from an automobile horn or loudspeaker that are emitted as the doors are unlocked, the alarm disabled, or the panic button actuated can serve the auxiliary function of directing the user to their vehicle. For example, these noises can be recognized by the vehicle owner from some distance so that the owner can, by listening, home-in on and locate their vehicle in a large and/or crowded parking area.

Most remotely actuated systems used in automobiles that have some audio output are unsuitable for use to locate a car in a large parking lot because the typical remote actuating transmitter/receiver system does not have sufficient range to actuate a noise when the user is far from the vehicle. Accordingly, the users must be so near the vehicle upon actuation, that they are likely to find the vehicle visually before entering the range of their remotely actuated audible device. Furthermore, the low power level of typical remote unlocking devices, automatic starters and alarm systems, for example, requires knowledge of the vehicles location because the transmitter must be aimed at the receiver. The volume and duration of the emitted noise in many of these systems is also typically insufficient to allow homing to the vehicle in very large parking lots.

Typical remotely actuated audible systems are also unsuitable for use in locating automobiles in large parking lots because they do not emit a sufficiently distinctive sound. Most either emit a horn beep, a common chirp sound from a loudspeaker, or a common siren. When multiple owners are simultaneously actuating their remote systems, such as, for example, when leaving a crowded sporting event, where vehicle location would be most useful, multiple systems are likely to emit the same sound thereby hindering the users' ability to home in on their own vehicles.

### SUMMARY OF THE INVENTION

Embodiments of the present invention provide a device and method for locating an object such as a vehicle in a parking lot by remotely actuating playback circuitry in communication with a loudspeaker disposed with the object. The device can be capable of recording and playing back audio signals from any number of sources. A portable transmitter carried by the user can activate the playback circuitry from a distance, for example, of at least several hundred feet and the loudspeaker can be heard from a similar distance. In certain embodiments, the user can remotely select between a plurality of audio streams to be played back and/or adjust the volume of the played back audio stream.

An illustrative embodiment of the present invention provides an apparatus for locating an object having, an input port, conversion circuitry in communication with the input port and recording circuitry in communication with the conversion circuitry. Remotely actuate-able playback circuitry is provided in communication with the recording circuitry. The playback circuitry includes a loudspeaker disposed with the object.

In a particular embodiment, the conversion circuitry is adapted to receive an audio signal from the input port in a first encoded format and output a digital signal representing the audio signal to the recording circuitry. The digital signal of this embodiment can be formatted for storage in the recording circuitry. For example, the first encoded format can be an MP3 signal as known in the art or a WAV file from a computer sound card as known in the art. The input port can include at least one of a USB port, an electrical connector, or an optical connector port, for example.

In a particular embodiment, the recording circuitry includes memory circuitry and can include, for example, removable flash memory cards. The playback circuitry can include digital to analog conversion circuitry in communication with the memory and with amplifier circuitry wherein the amplifier circuitry is adapted to drive the loudspeaker. In a particular embodiment, the loudspeaker produces sound at an amplitude that can be heard from of about 1000 feet.

Playback circuitry used in embodiments of the present invention can include a radio frequency receiver adapted to receive a radio frequency actuation signal from a remote transmitter, wherein upon receipt of the actuation signal by the receiver, the playback circuitry is actuated to playback an audio stream stored in the recording circuitry. Embodiments of the present invention also include a portable transmitter adapted for remotely actuating the playback circuitry.

Another particular embodiment of the invention includes an input port, recording circuitry in communication with the input port and adapted to receive and store an audio signal from the input port, and conversion circuitry in communication with the recording circuitry. The conversion circuitry is adapted to receive the audio signal from the recording circuitry in a first format, convert the audio signal to an output formatted signal and communicate the output formatted signal to remotely actuate-able playback circuitry including a loudspeaker disposed with the object. Certain embodiments of the present invention can also include means for remotely adjusting the volume of the played back signal. This embodiment can also include a portable transmitter adapted for remotely actuating the playback circuitry.

Embodiments of the present invention can also include means for transferring pre-recorded audio signals to the recording circuitry in communication with the recording circuitry. Particular embodiments also include means for selecting at least one of a plurality of pre-recorded audio signals for communication to the recording circuitry.

In another embodiment, the present invention includes a method for locating an object including the steps of disposing a loudspeaker with the object, recording an audio signal, playing back the audio signal through the loudspeaker upon remote transmission of an actuation signal and determining the object's location by audibly tracking the source of the played back audio signal. In exemplary embodiments, the object is a vehicle.

Particular embodiments of the present invention include providing a communication link between a microphone and recording circuitry for recording a voice signal to the recording circuitry and/or providing a communication link between a recorded or received audio source and recording circuitry for recording an audio signal from the recorded or received audio source.

Embodiments of the present invention also include recording the audio signal on recording circuitry having electronic memory wherein the recording circuitry is in communication with playback circuitry adapted for amplifying and playing back the audio signal through the loudspeaker upon receipt by the playback circuitry of a remotely transmitted actuation signal.

### BRIEF DESCRIPTION OF THE DRAWINGS

The foregoing and other features and advantages of the present invention will be more fully understood from the following detailed description of illustrative embodiments taken in conjunction with the accompanying drawings in which:

FIG. 1 is a functional block diagram of an apparatus for locating an object according to an illustrative embodiment of the present invention;

FIG. 2 is a functional block diagram of an apparatus for locating an object according to an alternative embodiment of the present invention; and

FIG. 3 is a process flow diagram of a method for locating an object according to an illustrative embodiment of the present invention.

### DETAILED DESCRIPTION

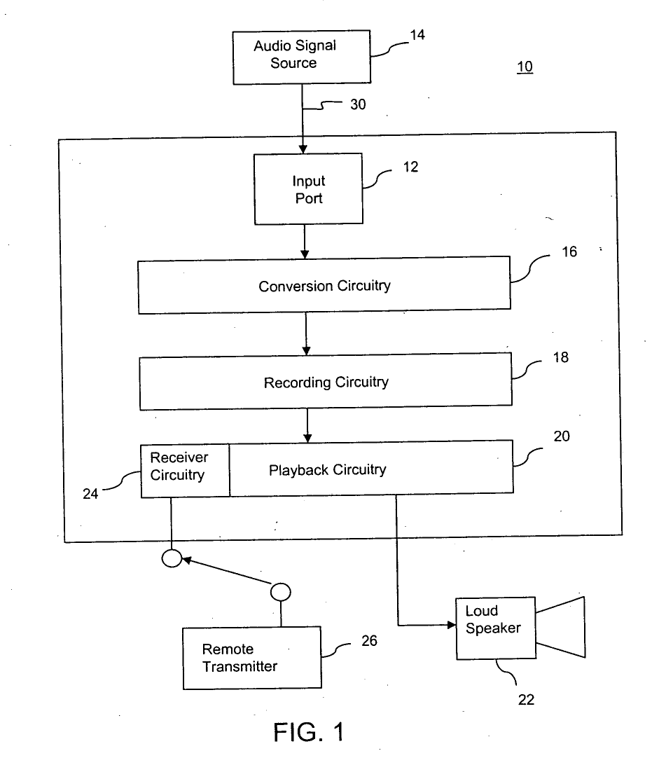

An exemplary object locating apparatus 10 according to an illustrative embodiment of the present invention is described first with reference to FIG. 1. The exemplary apparatus 10 includes an input port 12 in communication with recording circuitry 18. The recording circuitry is in communication with playback circuitry 20 which include receiver circuitry 24 for remote actuation. The playback circuitry is in communication with a loudspeaker 22 which is disposed with the object to be located. A remote transmitter 26 is in communication with the receiver circuitry 24. The input port 12 is adapted to receive audio signals from an audio signal source 14 through a communication link 30.

An audio source 14 can be any device or circuitry that is adapted for communicating an audio signal. Exemplary audio sources include microphones, computer sound cards, audio players such as MP3 players, compact disk (CD) players, radios, audio tape players. Exemplary audio sources can also include memory devices capable of storing audio information, for example, memory cards or USB devices having audio information stored thereon. The input port 12 can be one or more connector port and/or circuitry adapted for communication with an audio source 14 to receive an audio signal therefrom. The communication link 30 between an audio source 14 and input port 14 can be a conducive path such as a USB cable or ribbon cable, an optical path or a radio link and will generally depend on the type of audio source 14 to be used.

It is envisioned that certain implementations of the present invention will include a plurality of input ports 12 which may be of different types and adapted for receiving audio signals from different type audio sources. Persons skilled in the art should appreciate that such implementations may easily be made without departing from the scope of the present invention.

An exemplary embodiment of the present invention uses a computer sound card interface module having 5 conductors as a conductive path 30 to transfer audio signals embodied as WAV sound files from a computer which serves as the audio signal source 14 to a 5-pin connector which serves as the input port 12 in the locating apparatus 10. The exemplary embodiment combines the input port 14, conversion circuitry 16, recording circuitry 18 and portions of the playback circuitry 20 of the present invention in one module which is commercially available from ELK Products Inc. of Hilderbran, N.C., U.S.A. and which is identified as the ELK-120 v.2.

Conversion circuitry 16 is provided when necessary, as known in the art, to change the format of the audio signal from a format received at the input port 12 to a format suitable for storage in recording circuitry 18. It is envisioned that in certain implementations of the present invention, such as a direct memory transfer from a storage-type audio signal source to the recording circuitry 18, no conversion circuitry will be required. In such implementations, the input port 12 may be placed in direct communication with the recording circuitry 18. In implementations having more than one input port and adapted to receive audio signals in more than one format, the conversion circuitry 16 should be adapted for converting any of the input audio signal formats into a format suitable for storage in the recording circuitry 18.

Recording circuitry 18 receives a signal from the conversion circuitry 16 or input port 12 in a format suitable for storage. Virtually any type of audio signal and/or digital recording circuitry known in the art can be used with out departing from the scope of the present invention. For example, it is envisioned that an electronic read only memory (RAM) chip will typically be used in the various implementations of the present invention. However recoding circuitry such as audio tape circuitry and circuitry comprising optical disk technologies may also be used as recording circuitry within the scope of the present invention.

The playback circuitry 20 of the present invention is capable of being remotely actuated to play back an audio signal stored in the recording circuitry 18 through a loudspeaker 22. Persons having ordinary skill in the art should understand that either the playback circuitry 20 or the loudspeaker 22 will have an audio amplifier circuitry incorporated therein to provide sufficient power to drive the loudspeaker 22.

In an illustrative embodiment of the present invention, the playback circuitry 20 includes receiver circuitry 24 which is adapted for receiving an actuation signal from a remote transmitter 26. The remote transmitter 26 can be a radio frequency (RF) device as known in the art and which can be incorporated in an automobile key or key ring. It is envisioned that certain embodiments of the remote transmitter 26 will include a single actuation button to activate playback of a stored audio signal. Other embodiments of the present invention can include a plurality of buttons and circuitry adapted to send a particular signal to the receiver circuitry to select one of a plurality of stored audio signals and/or to adjust the volume of the played back signal.

An exemplary embodiment of the present invention can be implemented using a high frequency transmitter which serves as the remote transmitter 26 in communication with a superheterodyne receiver antenna assembly which serves as the receiver circuitry 24. The high frequency transmitter and superheterodyne receiver antenna assembly used in the exemplary embodiment have a range of about 1000 feet and are commercially available, for example, from Audiovox Electronics Corp., Hauppage, N.Y. as part of a 3 Channel Remote Start and Keyless Entry System, Model APS-55LRa.

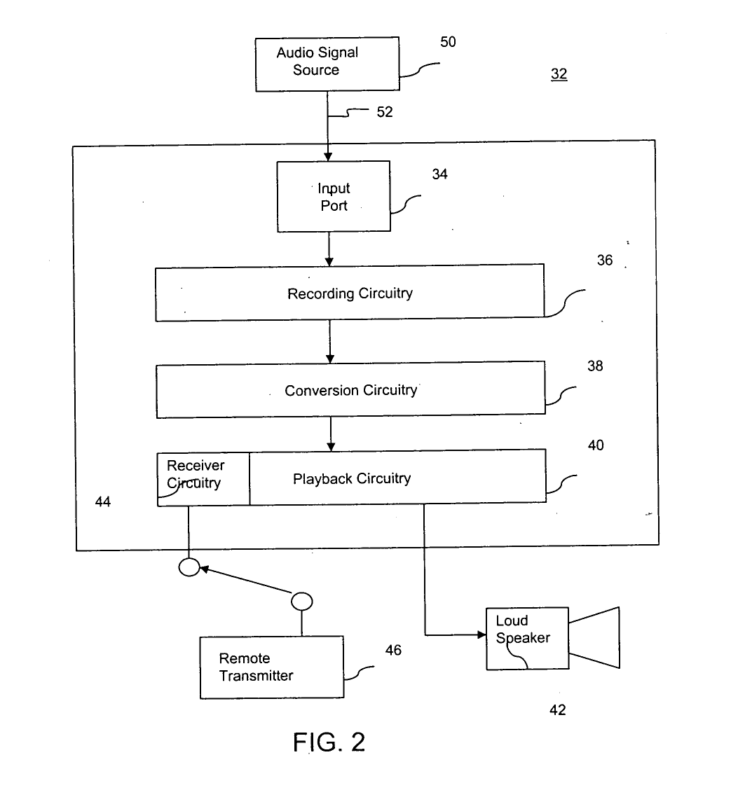

An object locating apparatus according to an alternative embodiment of the invention is described with reference to FIG. 2 in which conversion circuitry is used to change the format of an audio signal after it has been captured by the recording circuitry.

The exemplary apparatus 32 includes an input port 34 in communication with recording circuitry 36. The recording circuitry 36 is in communication with conversion circuitry 38. The conversion circuitry 38 is in communication with playback circuitry 40 which include receiver circuitry 44 for remote actuation. The playback circuitry 40 is in communication with a loudspeaker 42 which is disposed with the object to be located. A remote transmitter 46 is in communication with the receiver circuitry 44. The input port 34 is adapted to receive audio signals from an audio signal source 50 through a communication link 52.

Conversion circuitry 38 is provided when necessary, as known in the art, to change the format of the audio signal from a format in which it was stored in the recording circuitry 36 to a format suitable for playing back by playback circuitry 40 through the loudspeaker 42. It is envisioned that in certain implementations of the present invention, such as a direct memory transfer from a storage-type audio signal source to the recording circuitry 18, no conversion circuitry will be required. In such implementations, the recording circuitry may be placed in direct communication with the recording circuitry playback circuitry 40.

In implementations that are adapted to store audio signals in more than one format, the conversion circuitry 38 should be adapted for converting any of the input audio signal formats into a format suitable for playing back by the playback circuitry 40.

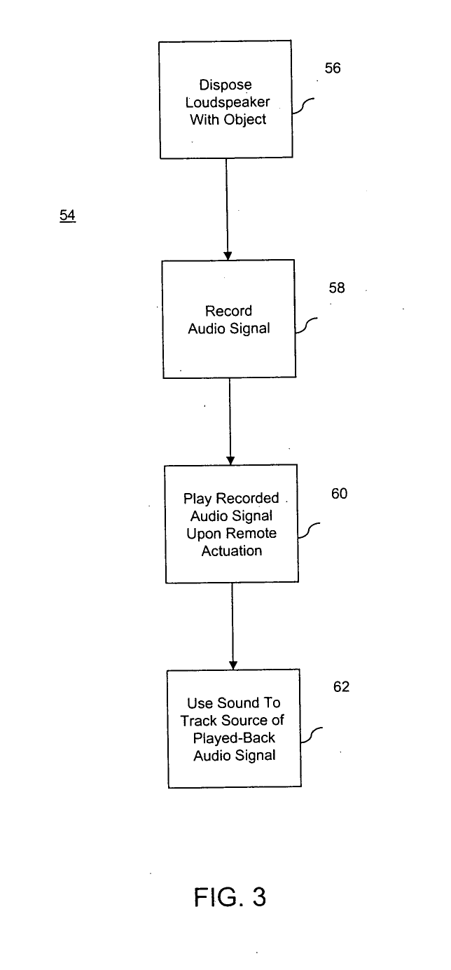

An exemplary method for locating an object according to an illustrative embodiment of the present invention is described with reference to FIG. 3. In a first preliminary step 56, a loudspeaker is disposed with the object that may need to be located. In a second preliminary step 58, an audio signal is recorded. Persons having ordinary skill in the art should appreciate that the first and second preliminary steps can be performed in any order. When a user wishes to locate the object, the recorded audio signal is remotely actuated 60. The user can then track 62 the source of the played-back signal, by listening to the direction from which the sound originates.

In an illustrative embodiment, the object to be located is a vehicle in a large parking lot. The first preliminary step 56 takes place upon installation of a loudspeaker in the vehicle. Persons skilled in the art should appreciate that the method and apparatus of the present invention can be implemented using a loudspeaker that may already be installed in the vehicle, for example, as part of a vehicle alarm system.

In the second preliminary step 58 an audio signal is recorded for use in locating the vehicle. One of the benefits of the present invention is that a custom audio signal from virtually any audio source can be used to track and identify a user's vehicle. A user may choose to record a voice message, a piece of music, a customized horn, for example to help them identify their own vehicle and distinguish it from other vehicles which could be emitting sounds. This step can be performed once upon installation of the inventive apparatus into a vehicle, or can be performed numerous times to update the audio signals stored in the recording circuitry.

Although the present invention is described herein generally in terms of radio frequency remote actuation, persons having ordinary skill in the art should understand that the present invention can include numerous alternative means of remote actuation as known in the art. For example, it is envisioned that the present invention could be implemented by actuating the playback circuitry using a cellular telephone without departing from the scope of the present invention.

It should be understood that various modifications may be made to the embodiments disclosed herein. Therefore, the above description should not be construed as limiting, but merely as exemplification of the various embodiments. Those skilled in the art will envision other modifications within the scope and spirit of the claims appended hereto.

1. An apparatus for locating an object comprising:
an input port;
conversion circuitry in communication with said input port;
recording circuitry in communication with said conversion circuitry; and
remotely actuate-able playback circuitry in communication with said recording circuitry, said playback circuitry including a loudspeaker disposed with said object.

2. The apparatus according to claim 1 wherein said conversion circuitry is adapted to receive an audio signal from said input port in a first encoded format and output a digital signal representing said audio signal to said recording circuitry, said digital signal being formatted for storage in said recording circuitry.

3. The apparatus according to claim 2 wherein said first encoded format comprises one of MP3 of WAV files.

4. The apparatus according to claim 1 wherein said recording circuitry includes memory circuitry.

5. The apparatus according to claim 4 wherein said memory circuitry comprises removable flash memory cards.

6. The apparatus according to claim 1 wherein said playback circuitry includes digital to analog conversion circuitry in communication with said memory and with amplifier circuitry, said amplifier circuitry being adapted to drive said loudspeaker.

7. The apparatus according to claim 6, wherein said loudspeaker produces sound that can be heard from a range of about 1000 feet.

8. The apparatus according to claim 1 wherein said playback circuitry comprises a radio frequency receiver adapted to receive a radio frequency actuation signal from a remote transmitter, wherein upon receipt of said actuation signal by said receiver, said playback circuitry is actuated to playback an audio stream stored in said recording circuitry.

9. The apparatus according to claim 1 further comprising a portable transmitter adapted for remotely actuating said playback circuitry.

10. The apparatus according to claim 1 wherein said input port comprises at least one of a USB port, an electrical connector port, or an optical connector port.

11. An apparatus for locating a vehicle in a parking lot comprising:
an input port comprising at least one of a USB port, an electrical connector or an optical connector;
conversion circuitry in communication with said input port;
recording circuitry in communication with said conversion circuitry;
wherein said conversion circuitry is adapted to receive an audio signal from said input port in a first encoded format and output a digital signal representing said audio signal to said recording circuitry, said digital signal being formatted for storage in said recording circuitry; and
remotely actuate-able playback circuitry in communication with said recording circuitry, said playback circuitry comprising digital to analog conversion circuitry in communication with said recording circuitry and with amplifier circuitry, said amplifier circuitry being adapted to drive a loudspeaker disposed with said vehicle, and a radio frequency receiver adapted to receive a radio frequency actuation signal from a remote transmitter, wherein upon receipt of said actuation signal by said receiver, said playback circuitry is actuated to playback an audio stream stored in said recording circuitry by driving said loudspeaker.

12. The apparatus according to claim 11 further comprising a portable transmitter adapted for remotely actuating said playback circuitry.

13. An apparatus for locating an object comprising:
an input port;
recording circuitry in communication with said input port and adapted to receive and store an audio signal from said input port; and
conversion circuitry in communication with said recording circuitry and adapted to receive said audio signal from said recording circuitry in a first format, convert said audio signal to an output formatted signal and communicate said output formatted signal to remotely actuate-able playback circuitry including a loudspeaker disposed with said object.

14. The apparatus for locating an object according to claim 13 further comprising a portable transmitter adapted for remotely actuating said playback circuitry.

15. A method for locating an object comprising:
disposing a loudspeaker with said object;
recording an audio signal;
playing back said audio signal through said loudspeaker upon remote transmission of an actuation signal; and
determining said object's location by audibly tracking the source of said played back audio signal.

16. A method according to claim 15 wherein said object is a vehicle.

17. The method according to claim 15 further comprising:
providing a communication link between a microphone and recording circuitry for recording a voice signal to said recording circuitry.

18. The method according to claim 15 further comprising:
providing a communication link between a recorded audio source and recording circuitry for recording an audio signal from said recorded audio source.

19. The method according to claim 15 further comprising:
recording said audio signal on recording circuitry having electronic memory, said recording circuitry being in communication with playback circuitry adapted for amplifying and playing back said audio signal through said loudspeaker upon receipt by said playback circuitry of a remotely transmitted actuation signal.

20. The apparatus according to claim 1 comprising:
means for transferring pre-recorded audio signals to said recording circuitry in communication with said recording circuitry.

21. The apparatus according to claim 1 comprising:
means for selecting at least one of a plurality of pre-recorded audio signals for communication to said recording circuitry.

22. The apparatus according to claim 1 comprising:
means for remotely adjusting the volume of said loudspeaker.

23. The apparatus according to claim 1 comprising:
means for selecting one of a plurality of audio signals stored in said recording circuitry to be played back by said remotely actuate-able playback circuitry.
